(19) United States
(12) Patent Application Publication
(10) Pub. No.: US 2025/0271017 A1
(43) Pub. Date: Aug. 28, 2025

(54) STRIP OF FASTENERS AND FASTENING SYSTEM

(71) Applicant: Illinois Tool Works Inc., Glenview, IL (US)

(72) Inventors: Peter Johnston, Melbourne (AU); Benjamin Josef Vincent, Melbourne (AU)

(21) Appl. No.: 19/056,140

(22) Filed: Feb. 18, 2025

(30) Foreign Application Priority Data
Feb. 23, 2024 (AU) 2024900441
Jan. 30, 2025 (AU) 2025200634

(51) Int. Cl. F16B 15/08

(52) U.S. Cl. CPC F16B 15/08; F16B 2200/95

(57) ABSTRACT

A strip of fasteners for loading into a fastening tool, the strip of fasteners including a plurality of elongated fasteners arranged in a parallel side-by-side relationship, each of the elongated fasteners having a head for driving the fastener into a substrate, the strip being arranged such that the heads of the fasteners are located along one side of the strip, and wherein at least one fastener has a head with an indicator for indicating to an operator upon driving of said fastener that the strip is due for replacement.

### PRIORITY CLAIM

The present application claims priority to and the benefit of Australian Patent Application No. 2024900441, filed Feb. 23, 2024, and Australian Patent Application No. 2025200634, filed Jan. 30, 2025, the entire contents of each of which are incorporated herein by reference.

### FIELD

The present disclosure relates generally to construction and, more particularly, but not exclusively, to fasteners for loading into a fastening tool.

### BACKGROUND

It has been previously proposed to provide a strip of nails for loading into a fastening tool, for example in the form of a nailing tool. The nailing tool may be powered by a number of different mechanisms such as, for example, internal combustion of a charge provided from a replaceable can or canister.

However, the applicant has identified that there is a problem in that, with existing strips of nails, the strip of nails may be depleted at an inconvenient time. For example, the strip of nails may run out while a carpenter using the nailing tool is up a ladder or on a roof. This is particularly inconvenient and time-consuming where the strip of nails is depleted without warning, as the carpenter may be required to descend from the roof to access a fresh strip of nails to be loaded into the fastening tool.

The applicant has identified that it would be advantageous to provide an improved strip of fasteners for loading into a fastening tool, which addresses one or more of the disadvantages of existing fastener systems.

Examples of the present disclosure seek to provide an improved strip of fasteners and fastening system that obviates or at least alleviates one or more disadvantages of existing fastening systems, or which at least provides a useful alternative.

### SUMMARY

In accordance with one aspect of the present disclosure, there is provided a strip of fasteners for loading into a fastening tool, the strip of fasteners including a plurality of elongated fasteners arranged in a parallel side-by-side relationship, each of the elongated fasteners having a head for driving the fastener into a substrate, the strip being arranged such that the heads of the fasteners are located along one side of the strip, and wherein at least one fastener has a head with an indicator for indicating to an operator upon driving of said fastener that the strip is due for replacement.

Preferably, a plurality of fasteners form a subgroup of fasteners of the strip, and each fastener of the subgroup has a head with an indicator for indicating to an operator upon driving of said fastener that the strip is due for replacement.

Preferably, the indicator is in the form of a visual indicator.

In a preferred form, a plurality of adjacent fasteners form said subgroup. More preferably, the subgroup comprises a plurality of fasteners prior to a final fastener of the strip. Even more preferably, the subgroup comprises a plurality of fasteners beginning at an 8th fastener counting inwardly from an end of the strip. More generally, the subgroup may comprise a plurality of fasteners terminating at a final fastener to be fired prior to a safety lockout being applied on the firing mechanism of the fastening tool. In one form, the subgroup comprises six fasteners, including and terminating at a final fastener to be fired prior to a safety lockout being applied on the firing mechanism of the fastening tool. It is envisaged that other fastening tools may have a safety lockout that activates at a range of different fasteners along a compatible strip of fasteners.

More preferably, the subgroup comprises a plurality of fasteners including the 8^{th} through to the 13^{th} fasteners counting inwardly from an end of the strip.

Preferably, the indicator is formed by painting each fastener head of the subgroup with a paint. More preferably, the indicator is formed by painting each fastener head of the subgroup with a paint of distinctive color. Even more preferably, each of the painted heads is painted with a common color such that the heads are painted alike.

In accordance with another aspect of the present disclosure, there is provided a method of forming a strip of fasteners as defined above, the method including a step of forming the fasteners into the strip and, subsequently, a step of painting the indicator onto the or each fastener head of the subgroup.

Preferably, the strip includes a holding mechanism for holding the nails together in the strip formation. More preferably, the holding mechanism includes one or more frangible strips of material adhered along a side of the strip of fasteners.

In accordance with yet another aspect of the present disclosure, there is provided a fastening system comprising a fastening tool in combination with a strip of fasteners as defined above.

### BRIEF DESCRIPTION OF THE DRAWINGS

The present disclosure is further described by way of non-limiting example only, with reference to the accompanying drawings in which:

FIG. 1 is a side view of a strip of fasteners in accordance with one example embodiment of the present disclosure;

FIG. 2 is a perspective view of the strip of fasteners shown in FIG. 1;

FIG. 3 shows fasteners from the strip of fasteners shown in FIG. 1, subsequent to being driven into a substrate by a fastening tool;

FIG. 4 is a side view of a strip of fasteners in accordance with another example embodiment of the present disclosure;

FIG. 5 is a side view of the strip of fasteners shown in FIG. 4; and

FIG. 6 is a perspective view of the strip of fasteners shown in FIG. 4.

### DETAILED DESCRIPTION

While the features, devices, and apparatus described herein may be embodied in various forms, the drawings show and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, attached, connected, and the like, are not intended to be limited to direct mounting methods but should be interpreted broadly to include indirect and operably mounted, attached, connected and like mounting methods. This specification is intended to be taken as a whole and interpreted in accordance with the principles of the present disclosure and as understood by one of ordinary skill in the art.

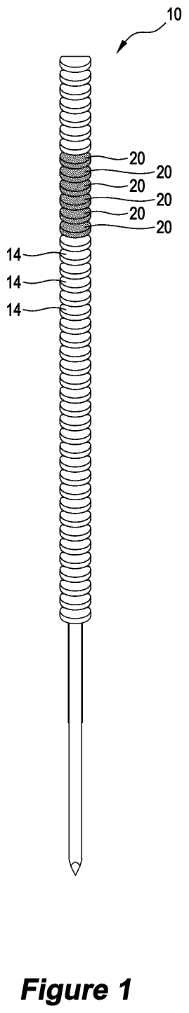

With reference to FIGS. 1 to 6, there are shown examples of a strip of fasteners 10 in accordance with the present disclosure. Advantageously, the strip of fasteners 10 has been developed by the applicant to provide a “low nail warning” to give advance notice to an operator of a fastening tool of an impending need to replace a strip of fasteners, in advance of the strip of fasteners actually being completely depleted. In doing so, this present disclosure has the scope to avoid a common frustration with uses of a fastening tool, such as carpenters, of running out of nails in their fastening tool at the least opportune time—for example up a ladder or on a roof.

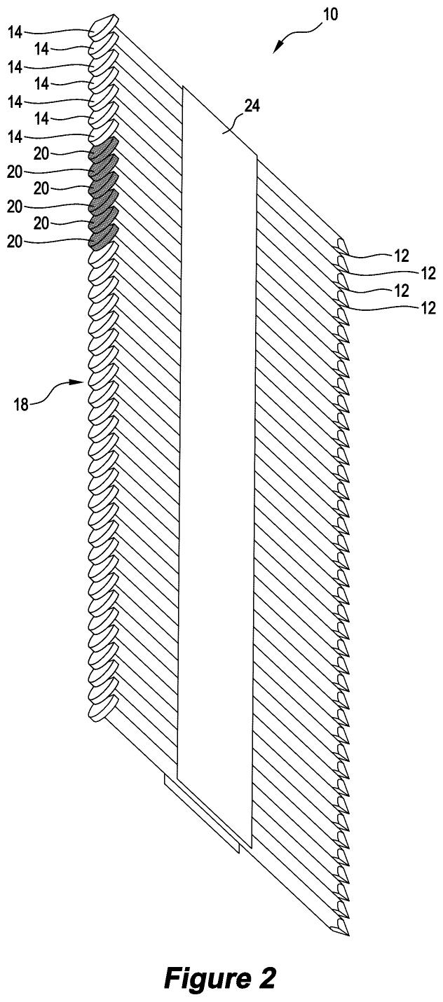

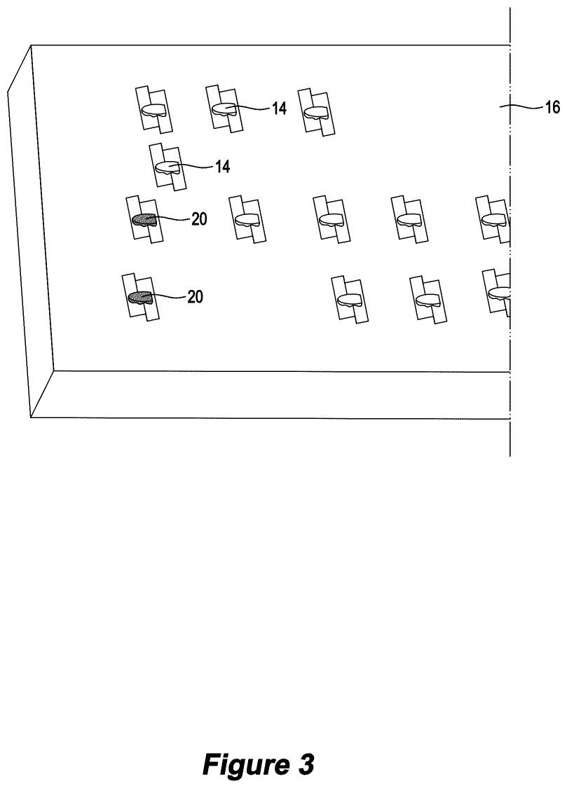

More specifically, as shown in FIG. 1 and FIG. 2 of the drawings, there is provided an example strip of fasteners 10 for loading into a fastening tool. The strip of fasteners 10 includes a plurality of elongated fasteners 12 arranged in a parallel side-by-side relationship (see FIG. 2), each of the elongated fasteners 12 having a head 14 for driving the fastener 12 into a substrate 16. The strip 10 is arranged such that the heads 14 of the fasteners 12 are located along one side 18 of the strip 10. At least one fastener 12 has a head 14 with an indicator 20 for indicating to an operator upon driving of said fastener 12 that the strip 10 is due for replacement. For example, with reference to FIG. 3, once the fasteners 12 are driven into the substrate 16 by the operator using the fastening tool, when the operator sees visually at least one indicator 20 on the head 14 of a fastener 12 driven into the substrate 16, the operator is made aware that the strip of fasteners is due for replacement. More specifically, in the preferred example of the present disclosure, there are six fasteners 12 having indicators 20—accordingly, when the operator sees the first indicator 20 on the head 14 of a fastener 12 driven into the substrate 16, then the operator is notified that there are only five more fasteners 12 available to be driven prior to a safety lockout being activated on the fastening tool, rendering the fasting tool unusable until the strip of fasteners 10 is replaced.

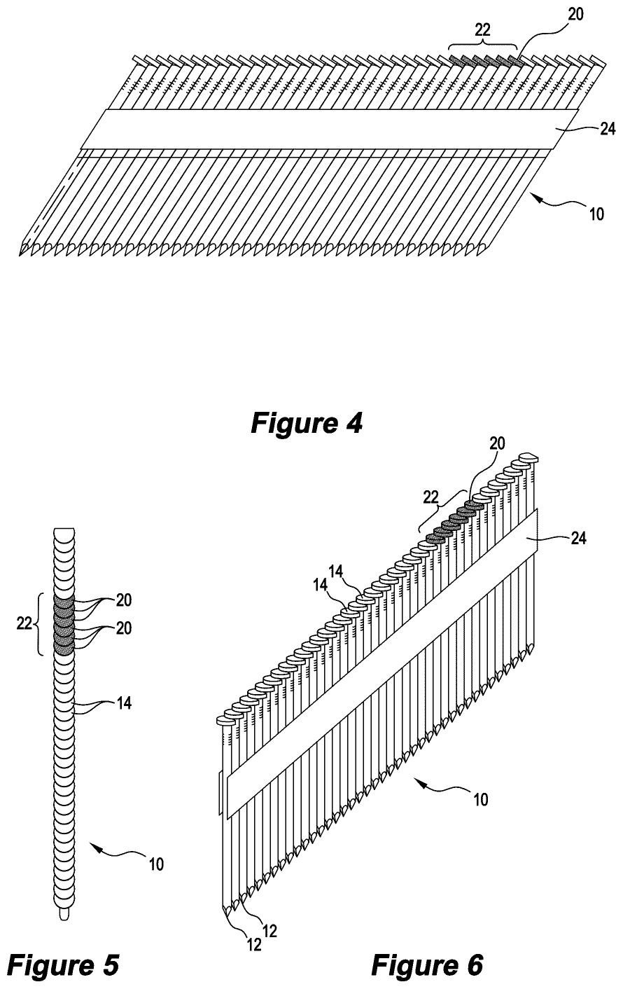

FIGS. 1 and 2 show a first example where the 5^{th} to 10^{th} fasteners 12 from a terminal end of the strip of fasteners 10 form a subgroup 22 of fasteners having indicators 20. FIGS. 4 to 6 show an alternative example in which the 8^{th} to 13^{th} fasteners 12 from a terminal end of the strip of fasteners 10 form a subgroup 22 of fasteners having indicators 20. The example shown in FIGS. 4 to 6 is specifically developed for a fastening tool which has a safety lockout activated after firing of the 8^{th} from last fastener.

Accordingly, each fastener 10 of the subgroup 22 has a head 14 with an indicator 20 for indicating to an operator upon driving of the fastener 12 that the strip 10 is due for replacement. In the examples shown in the drawings, the indicator 20 is in the form of a visual indicator.

In a preferred example shown in the drawings, there is a plurality of adjacent fasteners 12 (six fasteners to be precise) which form the subgroup 22. The subgroup 22 comprises a plurality of fasteners 12 prior to a final fastener of the strip 10. The number of fasteners between the subgroup 22 and the final fastener of the strip 10 will depend on the operation of the safety lockout mechanism of the compatible fasting tool. As mentioned above, in the example shown in FIGS. 4 to 6, the subgroup 22 comprises a plurality of fasteners 12 beginning at an 8th fastener counting inwardly from an end of the strip 10. The subgroup 22 includes a total of six fasteners 12, terminating at a final fastener (the 8^{th} fastener counting inwardly from an end of the strip 10) to be fired prior to a safety lockout being applied on the firing mechanism of the fastening tool.

As the subgroup 22 includes a total of six fasteners 12 beginning at an 8^{th} fastener counting inwardly from an end of the strip 10, the subgroup 22 comprises the plurality of fasteners including the 8^{th} through to the 13^{th} fasteners counting inwardly from the end of the strip 10. Each of the fasteners 12 in the subgroup 22 has a head 14 having an indicator 20.

Each indicator 20 is formed by painting each fastener head 14 of the subgroup 22 with a paint. As such, the indicator 20 is formed by painting each fastener head 14 of the subgroup 22 with a paint of distinctive color, which in the example shown in the drawings is a red/orange color. Each of the painted heads 14 is painted with a common color such that the heads 14 are painted alike.

The strip of fasteners 10 may be formed by a method including one step of forming the fasteners 12 into the strip 10 and, subsequently, another step of painting the indicator 20 onto the or each fastener head 14 of the subgroup 22.

As can be seen in FIGS. 2, 4, and 6, the strip 10 includes a holding mechanism 24 for holding the nails 12 together in the strip formation. The holding mechanism 24 can include one or more frangible strips of material (for example, paper) adhered along a side of the strip of fasteners 10.

Accordingly, as will be appreciated from the above, the applicant has determined a significant improvement to address a common frustration with carpenters running out of nails in their tool right at the least opportune time—up a ladder, on a roof, etc. The applicant has previously considered other forms of indicators but these other forms have been found to be unappealing owing to cost and complexity. Advantageously, with the present disclosure, the applicant has determined that it would be beneficial to paint some specific heads on the nail strip a bright orange so that as the tools are fired the carpenter sees the color and knows to replace the strip of nails. The nails to paint are quite specific—it would be the 8^{th} nail in the strip for perhaps 5 or 6 nails, so 8 through 13 from the end of the strip. The reason for the 8^{th} nail instead of the 1^{st} is that there is a “Last Nail Lock Out” feature in the tool that prevents the tool from firing when the magazine is empty. When there are only 8 nails left in the tool a spring pin pops out and stops the tool firing. Therefore, even though there are 8 nails in the tool, it is considered “empty” as it will no longer fire until it has been reloaded with a fresh strip of fasteners. If these nails (the 7^{th} to last fasteners in the strip) were painted they would be fired after the tool has been reloaded with new nails (and the pin is pushed back in). Accordingly, the 7^{th} to last fasteners in the strip are a tail end quantity of fasteners of the strip which are unable to be fired without insertion of a new strip of fasteners. The subgroup comprises a plurality of fasteners prior to, and not including, a final fastener of the strip, with subsequent fasteners after the subgroup each being without an indicator. The subsequent fasteners after the subgroup correspond to the tail end quantity of fasteners of the strip.

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above-described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge.

### List of Numbered Features

Strip of fasteners 10

Elongated fasteners 12

Head 14

Substrate 16

One side (of the strip) 18

Indicator 20

Subgroup 22

Holding mechanism 24

1. A strip of fasteners for loading into a fastening tool, the strip of fasteners comprising
a plurality of elongated fasteners arranged in a parallel side-by-side relationship, each of the elongated fasteners having a head,
the strip being arranged such that the heads of the fasteners are located along one side of the strip, and
wherein one of the fasteners has a head with an indicator that is configured to indicate to an operator upon driving of the fastener that the strip is due for replacement.

2. The strip of fasteners of claim 1, wherein the indicator is a visual indicator.

3. The strip of fasteners of claim 1, wherein a plurality of fasteners form a subgroup of fasteners of the strip, and wherein each fastener of the subgroup has a head with an indicator configured to indicate to an operator upon driving of the fastener that the strip is due for replacement.

4. The strip of fasteners of claim 3, wherein a plurality of adjacent fasteners form the subgroup.

5. The strip of fasteners of claim 3, wherein the subgroup includes a plurality of fasteners prior to a final fastener of the strip of fasteners.

6. The strip of fasteners of claim 5, wherein the subgroup includes a plurality of fasteners beginning at an 8^{th} fastener counting inwardly from an end of the strip of fasteners.

7. The strip of fasteners of claim 6, wherein the subgroup includes a plurality of fasteners including the 8^{th} through to the 13^{th} fasteners counting inwardly from an end of the strip of fasteners.

8. The strip of fasteners of claim 5, wherein the subgroup includes a plurality of fasteners terminating at a final fastener to be fired prior to a safety lockout being applied on a firing mechanism of the fastening tool.

9. The strip of fasteners of claim 8, wherein the subgroup includes six fasteners, including and terminating at a final fastener to be fired prior to a safety lockout being applied on a firing mechanism of the fastening tool.

10. The strip of fasteners of claim 3, wherein the indicator includes paint on each fastener head of the subgroup.

11. The strip of fasteners of claim 10, wherein the paint is of a distinctive color.

12. The strip of fasteners of claim 11, wherein each of the painted heads is painted with a common color.

13. The strip of fasteners of claim 1, which includes a holding mechanism that holds the nails together in the strip of fasteners.

14. The strip of fasteners of claim 13, wherein the holding mechanism includes one or more frangible strips of material adhered along a side of the strip of fasteners.

15. The strip of fasteners of claim 5, wherein the subgroup include a plurality of fasteners prior to a final fastener of the strip of fasteners, with subsequent fasteners after the subgroup each being without an indicator.

16. The strip of fasteners of claim 15, wherein the subsequent fasteners correspond to a tail end quantity of fasteners of the strip of fasteners that are unable to be fired without insertion of another new strip of fasteners.
